(19) United States
(12) Patent Application Publication
(10) Pub. No.: US 2025/0148471 A1
(43) Pub. Date: May 8, 2025

(54) SECURITY DETECTION METHOD AND APPARATUS FOR DECENTRALIZED FINANCE OF BLOCKCHAIN

(71) Applicant: Hainan University, Haikou City (CN)

(72) Inventors: Xiaoqi LI, Haikou City (CN); Wenkai LI, Haikou City (CN); Zongwei LI, Haikou City (CN)

(21) Appl. No.: 18/798,294

(22) Filed: Aug. 8, 2024

(30) Foreign Application Priority Data
Nov. 2, 2023 (CN) 202311448701.7

(51) Int. Cl. G06Q 20/40; G06Q 20/38

(52) U.S. Cl. CPC G06Q 20/4016; G06Q 20/389

(57) ABSTRACT

A security detection method and apparatus for decentralized finance of a blockchain. The security detection method includes the following steps: step S1, acquiring a malicious transaction call flow and collecting related smart contracts; step S2, constructing a control flowchart of the related smart contracts and simulating a call relation to connect an association graph; step S3, collecting data flow paths in the association graph and verifying path accessibility; step S4, constructing a data set by the collected accessible paths and inputting the data set into a DeFiTail model for training; and step S5, monitoring whether there is a malicious behavior in a transaction through the trained DeFiTail model. When the method is used, in all blockchains compatible with an Ethereum virtual machine, smart contract attack pattern detection at a bytecode level is implemented.

### FIELD OF TECHNOLOGY

The present invention belongs to the technical field of computer network security, and particularly relates to a security detection method and apparatus for decentralized finance of a blockchain.

### BACKGROUND

In a blockchain system, decentralized finance (DeFi) of a blockchain is a blockchain finance protocol taking smart contracts as function codes, which defines transaction operations of on-chain assets. The present invention mainly focuses on a DeFi protocol on a blockchain compatible with the Ethereum. As an important ecosystem on the blockchain system, the security problem of the DeFi is the key to correct and stable operation of the DeFi.

As a finance system on the blockchain, transaction information of a DeFi system will be irreversibly stored in the blockchain; the transaction information of the blockchain is divided into the following two forms: external transactions and internal transactions; the external transactions record transaction call processes initiated by external accounts, and the internal transactions record status transfer operations occurring in the contracts; however, the status transfer operations in the internal transactions are operation results of internal logic of the contracts; therefore, probable operation paths of data can be acquired by constructing a control flowchart in the smart contracts;
according to the existing security detection method for decentralized finance of a blockchain, the operation logic in the DeFi smart contracts is simulated by means of different technologies, and a pattern rule of attack incidents is summarized based on expert knowledge; then, a detection method is established in the rule to monitor whether there is a security problem in the transaction;
with respect to a detection method based on deep learning, a fragile pattern of vulnerabilities is automatically learned in the smart contracts in the DeFi attack incidents to identify the attack incidents; however, existing deep learning methods only focus on a single contract, and cannot fully consider interactions of a plurality of contracts in the DeFi protocol; therefore, deep learning is not ideal in terms of detection effect in the DeFi protocol;
under a background of DeFi, compared with conventional static analysis methods, a vulnerability detection technology based on deep learning has the following defects:
the DeFi attack incident detection method based on deep learning does not consider the multi-party interactions; the conventional static analysis methods, such as fuzz testing, have researched a condition that an internal logic flow of the single contract extends to call of the external contracts; although the static analysis methods have considered the external call flow, with evolution of the attacks, these detection methods also need to be re-designed due to the characteristic that the detection method is constructed according to priori knowledge of experts.

### SUMMARY

To solve the technical problem, the present invention provides a security detection method and apparatus for decentralized finance of a blockchain. An interactive call mode between a plurality of accounts, i.e., smart contracts and external accounts, under the DeFi background, is learned; and an external call flow in transaction data and an internal logic flow in the smart contracts are effectively utilized, and the security detection of a DeFi protocol is realized.

To achieve the above object, the present invention adopts the following technical solution:

A security detection method for decentralized finance of a blockchain, including:
step S1, acquiring a malicious transaction call flow and collecting related smart contracts;
step S2, constructing a control flowchart of the related smart contracts and simulating a call relation to connect an association graph;
step S3, collecting data flow paths in the association graph and verifying path accessibility;
step S4, constructing a data set by the collected accessible paths and inputting the data set into a DeFiTail model for training; and
step S5, monitoring whether there is a malicious behavior in a transaction through the trained DeFiTail model.

Preferably, in step S1, by analyzing right control incidents and flash loan attack incidents of the decentralized finance in REKT data set, the malicious transaction call flow including attack accounts and attacked fragile contracts is collected, and the related smart contracts in the malicious transaction call flow are extracted.

Preferably, step S2 specifically includes:
step 21, acquiring a control flow direction in each contract by constructing the control flowchart of the related smart contracts;
step 22, simulating the transaction call flow direction to acquire data flow directions between the plurality of contracts; and
step 23, connecting the control flow directions and the data flow directions to form the association graph.

Preferably, step S3 specifically includes:
step 31, by taking a function entry of a caller contract as a starting point, collecting the data flow paths in the association graph;
step 32, executing a stack operation that records proceeding of each data flow by using a symbol, and verifying whether stack elements needed for each stack operation are enough to verify each branch condition in the data flow, so as to determine whether the data flow is accessible; and
step 33, collecting all accessible data paths by determining the accessibility of all data flows.

Preferably, step S4 specifically includes:
step 41, one-hot encoding all operation code data in the accessible data paths as a data path embedding vector, and using the data path embedding vector as an input to train the DeFiTail model;
step 42, constructing a heterogeneous graph on the plurality of data paths and acquiring relational features between all operation code data and the data paths in an adjacent matrix;
step 43, truncating a length of a single data path embedding vector into a fixed size through a Transformer encoder structure to acquire local features of each data path;
step 44, embedding the data path features acquired in step 43 into the adjacent matrix, complementing the adjacent matrix acquired in step 42, and obtaining global data path features by using a graph convolution neural network;
step 45, fusing the global features acquired in step 44 and the local features acquired in step 43 to obtain final data path features; and
step 46, calculating whether the data path features acquired in step 45 are secure through a softmax layer.

Preferably, step S5 specifically includes:
step 51, collecting all transaction data within a special time interval;
step 52, sequentially constructing a transaction flow direction through a timestamp attribute of the transaction, and constructing the association graph of the related contracts by using the method in step S2;
step 53, collecting the data paths by using the method in step S3, and verifying the accessibility of the data paths to acquire the accessible data paths; and
step 54, one-hot encoding the data paths acquired in step 53 and inputting the data paths into the DeFiTail model to determine whether the data paths are secure.

The present invention further provides a security detection apparatus for decentralized finance of a blockchain, including:
a first acquisition module, configured to acquire a malicious transaction call flow and collect related smart contracts;
a construction module, configured to construct a control flowchart of the related smart contracts and simulate a call relation to connect an association graph;
a second acquisition module, configured to collect data flow paths in the association graph and verify path accessibility;
a training module, configured to construct a data set by the collected accessible paths and input the data set into a DeFiTail model for training; and
a detection module, configured to monitor whether there is a malicious behavior in a transaction through the trained DeFiTail model.

Preferably, the construction module includes:
a first acquisition unit, configured to acquire a control flow direction in each contract by constructing the control flowchart of the related smart contracts;
a second acquisition unit, configured to simulate the transaction call flow direction to acquire data flow directions of the plurality of contracts; and
a connecting unit, configured to connect the control flow directions and the data flow directions to form the association graph.

Preferably, the second acquisition module includes:
a third acquisition unit, configured to, by taking a function entry of a caller contract as a starting point, collect the data flow paths in the association graph;
a verifying unit, configured to execute a stack operation that records proceeding of each data flow by means of a symbol, and verify whether stack elements needed by each stack operation are enough to verify each branch condition in the data flow, so as to determine the data flow is accessible; and
a fourth acquisition unit, configured to collect all accessible data paths by determining the accessibility of all data flows.

Preferably, the training module includes:
a first processing unit, configured to one-hot encode all operation code data in the accessible data paths as a data path embedding vector, and use the data path embedding vector as an input to train the DeFiTail model;
a fifth acquisition unit, configured to construct a heterogeneous graph on the plurality of data paths and acquire relational features between all operation code data and the data paths in an adjacent matrix;
a sixth acquisition unit, configured to truncate a length of a single data path embedding vector into a fixed size and acquire local features of each data path through a Transformer encoder structure;
a second processing unit, configured to embed the data path features acquired into the adjacent matrix, complement the adjacent matrix acquired, and obtain global data path features by using a graph convolution neural network;
a fusing unit, configured to fuse the global features and the local features to obtain final data path features; and
a calculating unit, configured to calculate whether the data path features acquired are secure through a softmax layer.

Compared with the prior art, the present invention has the following beneficial effects:
Under circumstance of multi-party interactions, the present invention is capable of realizing more advantageous effects: the present invention learns the attack pattern for the decentralized finance by using the deep learning technology for the first time in combination with the external transaction call flow relation and the internal logic flow relation of the smart contracts; besides, to guarantee the correctness of the connection between the call flow and the logic flow, the symbol executing stack technology will be used for verifying all stack operations; further, as the DeFi protocol has various and complex functions, its data path length will greatly exceed the length of data in other normal contracts; therefore, to better learn other features, the graphic convolutional model and the Transformer model are jointly applied to this model for learning the global features and the local features, respectively; finally, the two portions of features are combined by weighting to obtain the final feature vector, and protocol fragility is monitored through the softmax layer; the method disclosed by the present invention includes: acquiring the data of the external transaction flow and the internal logic flow and connecting them to the association graph; and then acquiring the data path therein, and acquiring the local features and the global features of the path through the Transformer model and the graph neural network. The way of fusing the local features and the global features improves the malicious behavior monitoring effect to a certain extent.

### BRIEF DESCRIPTION OF THE DRAWINGS

In order to describe the technical solutions in embodiments of the present invention more clearly, the drawings required for describing the examples are briefly introduced below. Apparently, the drawings in the following description are merely some embodiments of the disclosure, and those of ordinary skill in the art would also be able to derive other drawings from these drawings without making creative efforts.

FIG. 1 is a flowchart of a security detection method for decentralized finance of a blockchain in an embodiment of the present invention;

FIG. 2 is a flowchart of another security detection method for decentralized finance of a blockchain in the embodiment of the present invention; and

FIG. 3 is a schematic diagram of a symbol executing stack technology for verifying accessibility of data paths.

### DESCRIPTION OF THE EMBODIMENTS

The technical solution in the embodiments of the present invention will be clearly and completely described below in combination with the drawings in the embodiments of the present invention. Apparently, the embodiments described are merely some rather than all of the embodiments of the present invention. On the basis of the embodiments in the present invention, all other embodiments obtained by those skilled in the technical field without creative efforts fall into the scope of protection of the present invention.

In order to make the above objectives, features, and advantages of the present invention more obvious and understandable, the present invention will be further described below in combination with drawings and specific embodiments.

### Embodiment 1

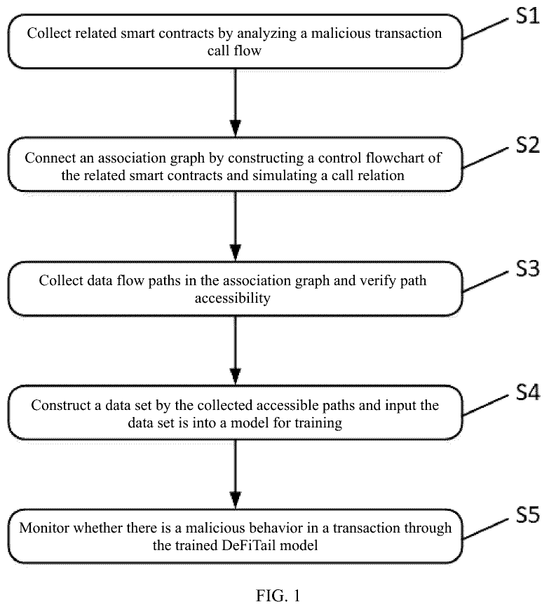

As shown in FIG. 1, the embodiment of the present invention provides a security detection method for decentralized finance of a blockchain, including the following steps:
step S1, related smart contracts are collected by analyzing a malicious transaction call flow;
step S2, an association graph is connected by constructing a control flowchart of the related smart contracts and simulating a call relation;
step S3, data flow paths in the association graph are collected and path accessibility is verified;
step S4, a data set is constructed by the collected accessible paths, and the data set is inputted into a model for training; and
step S5, whether there is a malicious behavior in a transaction is monitored through the trained DeFiTail model.

As an implementation of the embodiment of the present invention, in step S1, the malicious DeFi incident in a REKT database is analyzed to acquire the information of the transaction call flow thereof and collect the related smart contracts therein; and moreover, the related smart contracts are sequentially stored according to the call relation.

As an implementation of the embodiment of the present invention, in step S2, the association graph is connected by constructing the control flowchart of the related smart contracts and simulating the call relation. It specifically includes:
step 21: a control flow in the smart contract is acquired by constructing the control flowchart of all the smart contracts, that is, the internal logic flow;
step 22: an external call flow direction is searched through an operation code skipping syntax rule; and
step 23: the related smart contracts are connected by taking the call flow as an edge to construct the association graph.

As an implementation of the embodiment of the present invention, in step S3, data flow paths in the association graph are collected and path accessibility is verified. It specifically includes:
step 31: in the association graph in step 23, started from a function entry basic block, the data flow paths are collected by using a depth-first traversal algorithm;
step 32: all stack operation data of the operation code is recorded by using the symbol executing technology, and in the data flow path executing process, in a case that the data in the stack accords with the quantity needed by the operation code, it is considered that the path is accessible, and otherwise, it is considered that the path is inaccessible; and
step 33: all data flow paths collected in step 31 are verified through step 32.

As an implementation of the embodiment of the present invention, in step S4, a data set is constructed by the collected accessible paths, and the data set is inputted into a model for training, including:
step 41: an operation code sequence in the data flow path is sequentially acquired, the one-hot encoded operation code sequence is taken as a data path embedding vector, and the data path embedding vector is taken as an input for training the DeFiTail model;
step 42: an adjacent matrix with (the quantity of the paths+the quantity of the operation codes) as a dimension size is initialized, when two dimensions are the operation codes, a weight is acquired by using a PPMI technology, and when the dimensions are respectively the paths and the operation codes, a weight is acquired by using a TF-IDF technology; and when the two dimensions are same, a corresponding value in the matrix is 1;
step 43: the path feature is truncated into a fixed dimension size, and the path feature is acquired by using a Transformer encoding structure model and is taken as a local path node feature;
step 44, the data path features acquired in step 43 are embedded into the weight in the adjacent matrix acquired in step 42 with two dimensions being the path nodes to complement the adjacent matrix acquired in step 42, and global data path features are learned by using a graph convolution neural network;
step 45: the local path node features learned in step 43 and the global features of the data path learned in step 44 are acquired by using a weighted parameter as the final data path vector; and
step 46: whether the data path features acquired in step 45 are secure is calculated through the softmax layer; in conclusion, in the embodiments of the present invention, the operation codes are obtained from the bytecodes and are converted into operation codes in an SSA format by using a fusion semantic and function interface features as the features of the contracts, function parameters and function attributes are inferred from the bytecode smart contracts, the operation codes in the SSA format and the function parameters and the attributes are converted into the embedding vectors as their feature representations, then the two feature representations are fused as the features of the contracts, and finally, vulnerability types are decoded from the feature representations of the contracts.

As an implementation of the embodiment of the present invention, in step S5, whether there is a malicious behavior in a transaction is monitored through the trained DeFiTail model, including:
step 51: all transaction data of a specific DeFi protocol within a special time interval is collected;
step 52: the external call flows are sequentially connected according to the timestamp attribute, and then step S2 is executed to construct the external call flow and the internal logic flow and connect them to the association graph;
step 53: step S3 is executed to collect the data paths in the association graph, and verify the accessibility of the data paths to acquire the accessible data paths; and
step 54, the data paths acquired in step 53 are one-hot encoded and the data paths are inputted into the trained DeFiTail model to determine whether the data paths are secure, so as to monitor whether the DeFi protocol is secure.

### Embodiment 2

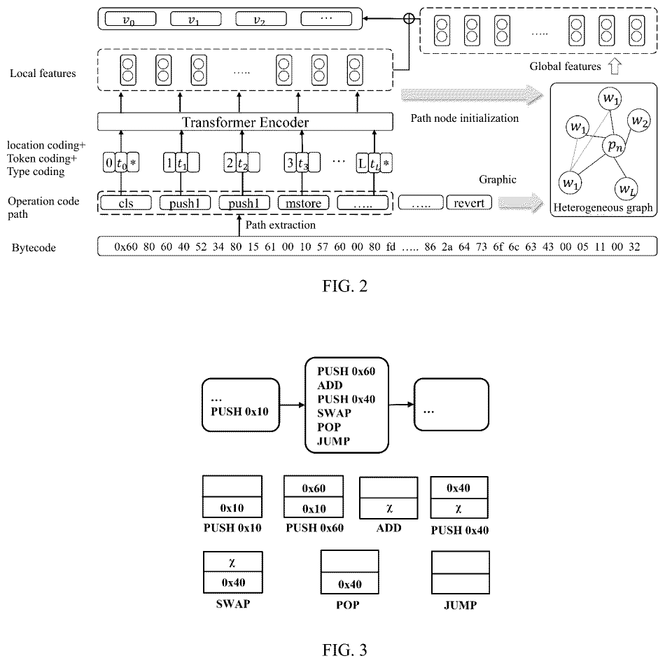

The embodiment of the present invention provides a security detection method for decentralized finance of a blockchain, including the following steps: malicious call flow collection, control flowchart construction, call relation connection, data flow extraction and verification, model training, and malicious behavior detection. As shown in FIG. 2, in the embodiment of the present invention, the data paths are acquired through path extraction, the local features of the paths are acquired through a Transformer encoder, the global features are acquired through a graph construction method, and after being aligned, the two features are fused into the final feature representations.

The malicious call flow collection process includes the following steps:

### 1) Analysis of the Call Flow in the Malicious Incident

A call flow direction of the DeFi security incident collected in the REKT database is analyzed, and the call flow of the malicious incident is collected from the perspective of the transaction.

### 2) Collection of Bytecode Smart Contracts in the Call Flow

For each call flow, the bytecode smart contracts existing therein are collected.

Construction of the control flowchart includes the following steps:

For the bytecode smart contract in each path, the bytecode form is converted into the operation code, and the contract is converted into the control flowchart by using a CFG_builder tool according to an operation code rule.

Calling the relation connection includes the following steps:

After the control flowcharts are constructed for all the contracts, a call relation connection is performed for each call flow, where pseudocodes of the connecting mode are as follows:

| | |
|---|---|
| 1 | CFGₜ, CFG_{c} ← CFG(contractₜ), CFG(contract_{c}); |
| 2 | Fₜ ← The set of function paths in CFGₜ; |
| 3 | F_{c} = {f_{c}: sig_{c}} ← The set of function paths and signatures in CFG_{c}; |
| 4 | rCFG ← CFGₜ; |
| 5 | for fₜ to Fₜ do: |
| 6 | if CALL ϵ fₜ then |
| 7 | fₚ,fₙ ← SplitCALL(fₜ); |
| 8 | [symbol] , [symbol] ← fₚ.⊥, fₙ.⊥; |
| 9 | end |
| 10 | end |
| 11 | for fₒₚ ϵ [symbol] do |
| 12 | if fₒₚ ϵ sig_{c} then |
| 13 | if RETURN ϵ f_{c} then |
| 14 | W(fₙ) ← W \ [symbol] (fₚ); |
| 15 | O(f_{c}) ← O ∪ [symbol] (fₙ); |
| 16 | end |
| 17 | O(fₚ) ← O \ [symbol] (fₙ); |
| 18 | O(fₚ) ← O ∪ f_{c}; |
| 19 | W(f_{c}) ← W ∪ [symbol] (fₚ); |
| 20 | end |
| 21 | end |
| 22 | return rCFG |

In the pseudocodes described above, the operation logic is as follows:

A target contract contractₜ and a call contract contract_{c} are inputted, and rCFG is outputted.

First, the control flowcharts of the target contract and the call contracts are initialized, and function paths therein are acquired, that is, the 1^{st} to 3^{rd} lines of the pseudocodes.

Then in the 5^{th} to 10^{th} line, whether the function in the call contract has the call operation code is determined, and the function is sliced into two blocks according to the CALL operation code, that is, fₚ and fₙ in the 7^{th} line.

Then, in the 11^{th} to 21^{st} lines, if there is a RETURN operation code in the function of the called contract, fₙ is increased to a rear-driven node set of the function, and fₚ in a front-driven node set of fₙ; if there is no RETURN operation code, fₙ in the rear-driven node set of fₚ is deleted, a rear-driven node set from fc to fₚ is increased, and a front-driven node set from fₚ to fc is increased.

According to the above pseudocode function, the control flowcharts of the two related smart contracts are recorded in rCFG.

Data flow extraction and verification includes the following steps:

The data flow in rCFG is collected according to rCFG constructed according to each call flow. The function entry serves as a starting point of the data flow, and terminating operation codes such as STOP, REVERT, and RETURN are termination points of the data flow.

For each data flow, the accessibility of the data flow is verified by using the symbol executing stack technology, where the working principle of the symbol executing stack is shown in FIG. 3. The data flow is traversed according to an operation code calculation rule. All calculated results use placeholders. In a case that the calculating resource is not occupied, whether the operation codes in the data flow can be normally used is determined, where the operation codes that cannot be normally used are regarded as path inaccessible.

Model training includes the following steps:

A corpus is constructed from all the trained data paths, and then a heterogeneous graph representation is constructed according to the corpus, and a weight matrix for graph learning is constructed.

The dimension of the weight matrix is (total quantity of paths+total quantity of operation codes)×embedding dimension. Matrix point numbers of the paths and the operation codes are acquired by using the Term Frequency-Inverse Document Frequency (TF-IDF) technology, and Matrix point numbers of the operation codes and the operation codes are acquired by Positive Pointwise Mutual Information (PPMI) technology.

The path accessible sequence is converted into the one-hot encoded form, then the length is truncated to the dimension size the same as the heterogeneous graph, and then the path features to the operation sequence characteristic are acquired by using the Transformer encoder as the local features.

Then, the path features are embedded into the weight matrix, and then the global features including the relation between the operation codes and the paths are learned in the heterogeneous graph and the weight matrix by using the graph convention technology.

Then, in combination of the local features and the global features as the final characteristic representation, whether there is a malicious behavior therein is determined through the softmax layer.

The model is trained in the above way to learn the pattern of the malicious behavior.

Malicious behavior detection includes the following steps:

Through the above trained DeFiTail model, after call relation connection and data flow extraction and verification of the contracts in the specific transaction call flow, the data flow is passaged to the model to detect whether there is the malicious behavior in the call flow to realize detection of the DeFi malicious behavior.

### Embodiment 3

The present invention further provides a security detection apparatus for decentralized finance of a blockchain, including:
a first acquisition module, configured to acquire a malicious transaction call flow and collect related smart contracts;
a construction module, configured to construct a control flowchart of the related smart contracts and simulate a call relation to connect an association graph;
a second acquisition module, configured to collect data flow paths in the association graph and verify path accessibility;
a training module, configured to construct a data set by the collected accessible paths and input the data set into a DeFiTail model for training; and
a detection module, configured to monitor whether there is a malicious behavior in a transaction through the trained DeFiTail model.

As an implementation of the embodiment of the present invention, the construction module includes:
a first acquisition unit, configured to acquire a control flow direction in each contract by constructing the control flowchart of the related smart contracts;
a second acquisition unit, configured to simulate the transaction call flow direction to acquire data flow directions of the plurality of contracts; and
a connecting unit, configured to connect the control flow directions and the data flow directions to form the association graph.

As an implementation of the embodiment of the present invention, the second acquisition module includes:
a third acquisition unit, configured to, by taking a function entry of a caller contract as a starting point, collect the data flow paths in the association graph;
a verifying unit, configured to execute a stack operation that records proceeding of each data flow by means of a symbol, and verify whether stack elements needed by each stack operation are enough to verify each branch condition in the data flow, so as to determine the data flow is accessible; and
a fourth acquisition unit, configured to collect all accessible data paths by determining the accessibility of all data flows.

As an implementation of the embodiment of the present invention, the training module includes:
a first processing unit, configured to one-hot encode all operation code data in the accessible data paths as a data path embedding vector, and use the data path embedding vector as an input to train the DeFiTail model;
a fifth acquisition unit, configured to construct a heterogeneous graph on the plurality of data paths and acquire relational features between all operation code data and the data paths in an adjacent matrix;
a sixth acquisition unit, configured to truncate a length of a single data path embedding vector into a fixed size and acquire local features of each data path through a Transformer encoder structure;
a second processing unit, configured to embed the data path features acquired into the adjacent matrix, complement the adjacent matrix acquired, and obtain global data path features by using a graph convolution neural network;
a fusing unit, configured to fuse the global features and the local features to obtain final data path features; and
a calculating unit, configured to calculate whether the data path features acquired are secure through a softmax layer.

The above embodiments are merely descriptions of preferred embodiments of the present invention rather than a limitation to the scope of the present invention. Various variations and improvements made on the technical solution by those of ordinary skill in the art shall fall within the protection scope determined by claims of the present invention without departing from the design spirit of the present invention.

1. A security detection method for decentralized finance of a blockchain, the method comprising:
acquiring, by an apparatus, a malicious transaction call flow by analyzing right control incidents and flash loan attack incidents of the decentralized finance in an REKT data set, to collect the malicious transaction call flow comprising attack accounts and attacked fragile contracts, and collecting smart contracts related to the malicious transaction call flow;
constructing, by the apparatus, a control flowchart of the smart contracts and simulating a call relation to connect an association graph;
collecting, by the apparatus, data paths in the association graph and verifying an accessibility of the data paths to acquire accessible data paths;
constructing, by the apparatus, a data set by the accessible data paths and inputting the data set into a model for training; and
determining, by the trained model, a malicious behavior in a transaction through the trained model;
wherein the step of verifying the accessibility of the data paths comprises:
executing a stack operation that records proceeding of data by using a symbol, and verifying whether stack elements needed for each stack operation are enough to verify each branch condition in the data, to determine whether the data paths are accessible;
wherein the step of constructing the data set comprises:
one-hot encoding data in the accessible data paths as a data path embedding vector, and using the data path embedding vector as an input to train the model;
constructing a heterogeneous graph according to a corpus constructed from the data paths and acquiring relational features between the data and the data paths in an adjacent matrix;
truncating a length of the data path embedding vector into a fixed size through a Transformer encoder structure to acquire local features of each data path;
embedding the data path features acquired in the step of truncating the length of the data path into the adjacent matrix, and obtaining global data path features by using a graph convolution neural network;
combining the global features acquired in the step of embedding the data path features and the local features acquired in the step of truncating the length of the data path to obtain final data path features; and
calculating whether the data path features acquired in the step of combining the global features are secure through a softmax layer; and
wherein the step of determining the malicious behavior in a transaction through the trained model comprises:
collecting all transaction data within a special time interval;
sequentially constructing a transaction flow direction through a timestamp attribute of the transaction, and constructing the association graph of the smart contracts by using the step of constructing the control flowchart;
collecting the data paths by using the step of collecting the data paths, and verifying the accessibility of the data paths to acquire the accessible data paths; and
one-hot encoding the data paths acquired in the step of collecting the data paths and inputting the data paths into the model to determine whether the data paths are secure.

2. (canceled)

3. The security detection method for decentralized finance of a blockchain according to claim 1, wherein the step of constructing the control flowchart comprises:
acquiring a control flow direction in each contract by constructing the control flowchart of the smart contracts;
simulating the transaction call flow direction to acquire data flow directions between the smart contracts; and
connecting the control flow directions and the data flow directions to form the association graph.

4. The security detection method for decentralized finance of a blockchain according to claim 3, wherein the step of collecting the data paths comprises:
by taking a function entry of a caller contract as a starting point, collecting the data paths in the association graph.

5. A security detection apparatus for decentralized finance of a blockchain implementing the security detection method for decentralized finance of the blockchain according to claim 1, the security detection apparatus comprising:
a first acquisition device, configured to acquire a malicious transaction call flow and collect smart contracts related to the malicious transaction call flow;
a construction device, configured to construct a control flowchart of the smart contracts collected in the first acquisition device and simulate a call relation to connect an association graph;
a second acquisition device, configured to collect data paths in the association graph simulated in the construction device and verify an accessibility of the data paths to obtain accessible data paths;
a training device, configured to construct a data set by the accessible paths in the second acquisition device and input the data set into a model for training; and
a detection device, configured to determine, by the trained model of the training device, a malicious behavior in a transaction.
